(19) United States
(12) Patent Application Publication
(10) Pub. No.: US 2013/0082225 A1
(43) Pub. Date: Apr. 4, 2013

(54) CAPSTAN MECHANISM

(71) Applicant: Wu-Chih HSIEH, Taichung City (TW)

(72) Inventor: Wu-Chih HSIEH, Taichung City (TW)

(21) Appl. No.: 13/250,143

(22) Filed: Sep. 30, 2011

(51) Int. Cl. B66D 1/04; B66D 1/14

(52) U.S. Cl. 254/342

(57) ABSTRACT

A capstan mechanism has one base, two location holes, one rotation axis, one driven gear set, one combination driving gear set and one rotation handle. Location holes on the base are needed to be made due to the combined style of the combination driving gear set and the rotation axis, and the hole diameter shall be big enough to let the rotation hole go through it. Thus the concentricity among the parts of the capstan mechanism is realized and the production cost is saved.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a capstan mechanism, and more particularly to an innovative one in which the combination driving gear set and rotation axis are in a combination style.

2. Description of Related Art Including Information Disclosed Under 37 CFR 1.97 and 37 CFR 1.98.

A capstan mechanism plays an important role in rolling steel cables, fabric tapes and many other similar ropes. Due to this function, it is widely used in setting up tennis nets and for dragging yachts and automobiles. In order to guarantee safety use, the structural strength of the mechanism must be carefully considered during design and production if it is intended to be used in high load situations.

The prior-art capstan mechanism is comprised of a base and a gear unit. The gear unit comprises of a driven wheel and an integral structure driving wheel in the two location holes fixed on the base. The rolling function is thus realized by the gear unit under the help of the rotation piece on one side of the driving wheel. However, it is found that such prior-art structure has the following problems in actual usage.

When installing the driving wheel of the integral structure of the prior-art capstan mechanism, two location holes are required due to assembling needs. As the driving wheel of the integral structure needs to be installed into the mechanism from one location hole, it shall be big enough, leading to different hole diameters between the two holes. Besides, while fixing the rotation axis on the hole with a bigger diameter, at least one fixing component shall be set between the hole and the rotation axis, thus concentricity error among the components during assembly will be increased. Also, power distribution shall be affected when the driving wheel bears radial load. In high load conditions, the mechanism strength may be not large enough to suffer and the production and manufacturing costs shall be increased for adding location components. Also, the design cost will be increased to design suitable location holes to match with the base resulting from different sizes of the driving wheel.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The feature of this “capstan mechanism” lies in its innovative construction of the combined style between the combined-style gear set and the rotation axis. Compared with the previous technologies, during the present invention, location holes on the base are needed to be made due to the combined style of the combination driving gear set and the rotation axis, and the hole diameter shall be big enough to let the rotation hole go through it. If there is any need to make a change to the load specification, one must select the collocation arrays of the gear wheel and gear disc according to the collocation method, set the engaged mean as one or two for each, etc. No more new design to this base is needed, thus the specification of the base could be used in all situations.

Due to the innovative construction, the diameter of the location holes shall be big enough for going through the rotation axis, thus the concentricity among the parts of the capstan mechanism is realized and production cost is saved.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of capstan mechanism of the present invention.

FIG. 2 is an exploded perspective view of capstan mechanism of the present invention.

FIG. 3 is an isolated sectional view of the base, rotation axis and combination driving gear set of the capstan mechanism of the present invention.

FIG. 4 is a schematic view of the rotation axis and combination driving gear set of the capstan mechanism of the present invention.

FIG. 5 is an operation schematic diagram of the capstan mechanism of the present invention.

FIG. 6 is an isolated sectional view of the single-collocated engaged mean of the gear wheel and gear disc of the capstan mechanism of the present invention.

### DETAILED DESCRIPTION OF THE INVENTION

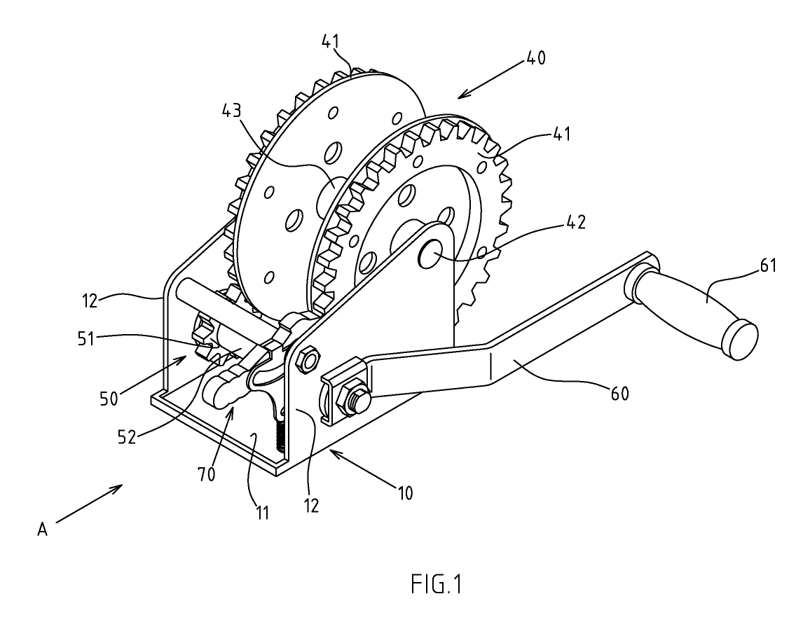

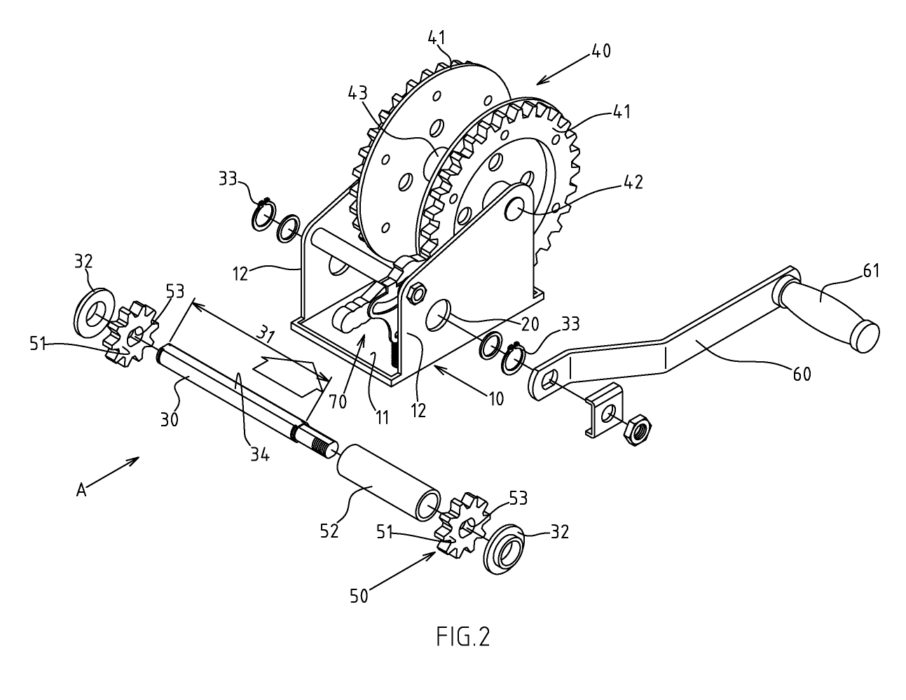

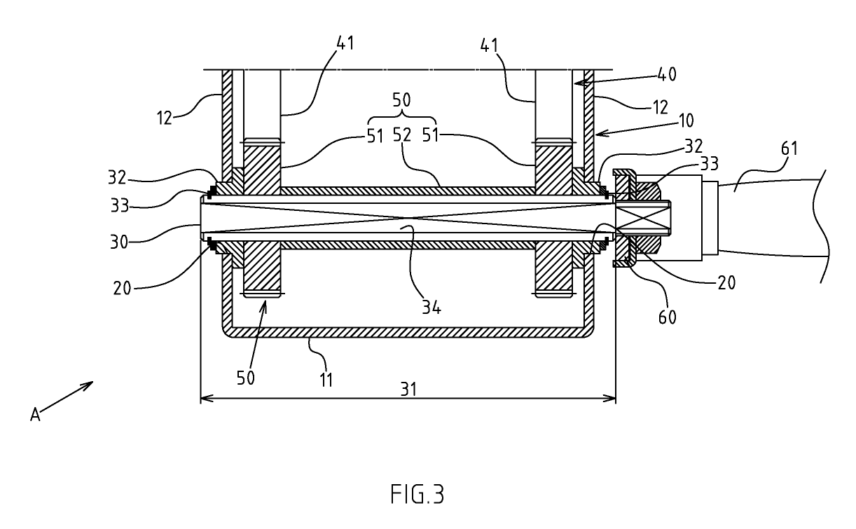

FIGS. 1, 2, 3 and 4 show some preferred embodiments of the capstan mechanism, but it shall be noted that these figures are only for reference and explanation, and shall not limit the patent application.

Said capstan mechanism A includes a base 10, which comprises a base plate 11 and two side plates 12. Two equant location holes 20 are fixed on the set positions of the two side plates 12 of the base 10 respectively.

A rotation axis 30 is installed through the two equant location holes 20 is able to rotate, and one axis assembled section 31 is formed. There is one driven gear set 40.

A gear disc 41 is at each side, and one fixed axis 42 is in the middle which is assembled between the two side plates 12 of the base, is able to rotate, and one roll section 43 is formed between the two gear discs 41.

A combination driving gear set 50 is combined to the axis assembled section 31 of the rotation axis 30 and able to rotate synchronously. The combination driving gear set 50 comprises one gear wheel 51 at each side and a space keeping component 52 at the center. Gear wheel 51 is engaged to the gear disc 41 of the driven gear set 40, making the combination driving gear set 50 able to drive the driven gear set 40.

A rotation handle 60 is assembled at the end of the rotation axis 30, and able to rotate the rotation axis 30 with the rotation handle 60 and force the combination driving gear set 50 to be engaged to and drive the driven gear set 40.

Of which, a bearing 32 and limit component 33 is equipped at the two sides of the rotation axis 30 to fix the rotation axis 30 into the location hole 20 on the two side plates 12 of the base 10. Due to the large enough holes of the two location holes 20, the concentricity degree among the parts of the capstan mechanism is guaranteed.

Of which, one end of the rotation handle 60 is equipped with one holding rod 61, and the other is connected to the rotation axis 30. The capstan mechanism A starts to work if the rotation handle is rotated by the holding rod 61.

Of which, a check mechanism 70 is set on the specified position of the base 10 to control the combination driving gear set 50 to rotate clockwise or anticlockwise.

Of which, each surface of axis assembled section 31 on rotation axis 30 is equiform.

When assembling capstan mechanism A, make sure the rotation axis 30 is able to insert through the location hole 20 by one side plate 12 of the base 10, and then complete assembly by going through the combination driving gear set 50.

Of which, the axis assembled section 31 of the rotation axis 30 forms the first combination section 34, and second combination section 53 at the matched position of the gear wheel 51 and first combination section 34, so that the first combination section 34 of the rotation axis 30 can go through and be fixed on the second combination section 53 of the gear wheel 51. Thus the combination driving gear set 50 could be driven to rotate synchronously with the rotation axis 30.

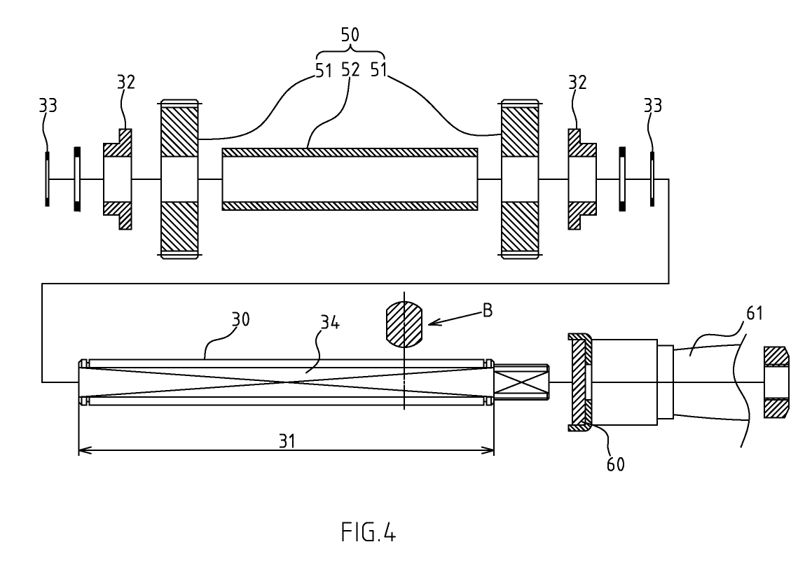

Of which, the radial surface of the axis assembled section 31 is of non-circular form (refer to the Arrow B in FIG. 4), and the second combination section 53 of the gear wheel 51 and the axis assembled section is equiform, so that the first combination section 34 and second combination section could be combined by the set position.

Of which, the interval keeping component 52, with hollow straight form, is equipped at the exterior of the axis assembled section 31 of the rotation axis 30 to fix the interval of the gear wheel 51 at the two sides.

According to the above-mentioned structure, composition and design, the capstan mechanism A under the present invention is operated as follows.

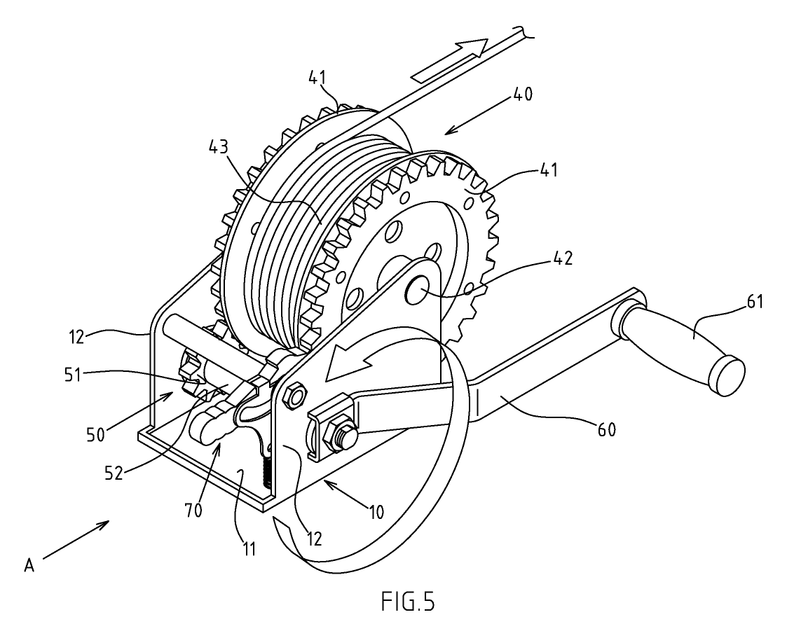

Referring to FIG. 5, the method for operating the capstan mechanism A under the present invention shall be: Rotate the rotation handle 60 to drive its connected rotation axis 30 by which the combination driving gear set 50 shall be driven synchronously, here, the gear wheel 51 of the combination driving gear set 50 and the gear disc 41 of the driven gear set 40 is driven by engaged together; considering the gear ratio between the gear wheel 51 and the gear disc 41, the capstan mechanism A is able to provide a larger rotating moment when the rotation moment of the rotation handle 60 is calculated by gear ratio. By this means, the roll section 43 of the driven gear set 40 is capable to complete the rolling task under the help of the increased rotation moment, convenient and labor-saving.

The check mechanism 70 is used to control the driven gear set 40 and generate a fixing effect and direction rotation ability, thus the checking phenomenon of the driven gear set 40 and combination driving gear set 50 due to the large tension on the ropes in roll section 43 when the check mechanism 70 is rolling could be avoided.

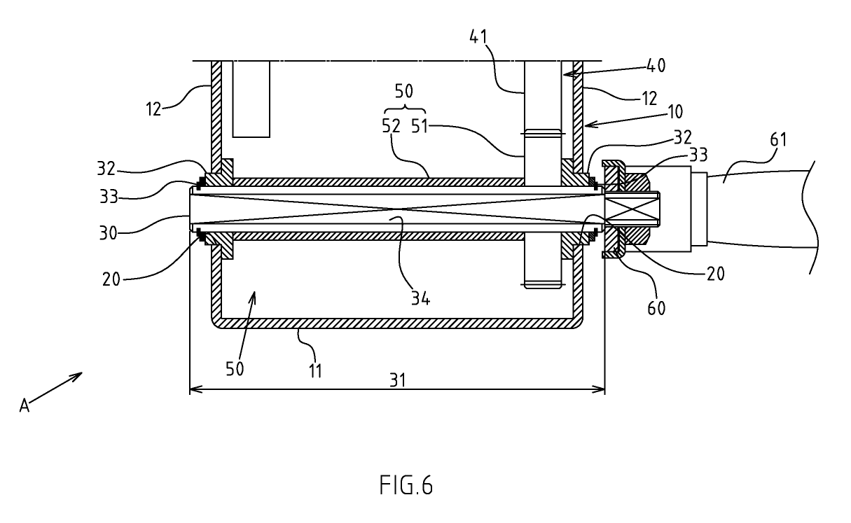

FIG. 6 shows another embodiment of the capstan mechanism, known as the combination pattern of the combination driving gear set 50 and the driven gear set 40, and a engaged mean for both gear wheel 51 and gear disc 41.

1. A capstan mechanism comprising:
a base which comprises a base plate and a side plate;
two equant location holes which are fixed on the set positions of the two side plates of the base respectively;
a rotation axis installed through the two equant location holes, able to rotate, and one axis assembled section is formed;
a driven gear set, with one gear disc at least one side, and one fixed axis in the middle which is assembled between the two side plates of the base, able to rotate, and one roll section is formed between the two gear discs;
a combination driving gear set which is combined to the axis assembled section of the rotation axis and able to rotate synchronously; the combination driving gear set comprises at least one gear wheel and space keeping component at the center; said gear wheel is engaged to the gear disc of the driven gear set, making the combination driving gear set able to drive the driven gear set;
a rotating handle, assembled at the end of the rotating axis, able to rotate the rotation axis with the rotation handle.

2. The structure defined in claim 1, wherein the engaged means between the combination driving gear set and the driven gear set is of dual gear wheel or dual gear disc.

3. The structure defined in claim 1, wherein one bearing and limit component is equipped at the two sides of the rotation axis to fix the rotation axis into the location hole on the two side plates of the base; one end of the rotation handle is equipped with one holding rod, and the other is connected to the rotation axis; the capstan mechanism starts to work if the rotation handle is rotated by the holding rod.

4. The structure defined in claim 1, wherein one check mechanism is set on the specified position of the base to control the combination driving gear set to rotate in clockwise or anticlockwise.

5. The structure defined in claim 1, wherein the axis assembled section of the rotation axis forms the first combination section, and second combination section at the matched position of the gear wheel and first combination section, making the first combination section of the rotation axis be possible to go through and fix on the second combination section of the gear wheel, thus the combination driving gear set could be driven to rotate synchronously with the rotation axis; the interval keeping component, with hollow straight form, is equipped at the exterior of the axis assembled section of the rotation axis to fix the interval of the gear wheel at the two sides.

6. The structure defined in claim 5, wherein the radial surface of the axis assembled section is of non-circular form, and the second combination section of the gear wheel and the axis assembled section is equiform, so that the first combination section and second combination section could be combined by the set position.
